(19) United States
(12) Patent Application Publication
(10) Pub. No.: US 2014/0052365 A1
(43) Pub. Date: Feb. 20, 2014

(54) BUS STOP AND SYSTEM CAPABLE OF PROVIDING DETAILED BUS SCHEDULES

(71) Applicants: TE-SHENG CHEN, Miaoli (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(72) Inventors: TE-SHENG CHEN, Miaoli (TW); XIAO-GUANG LI, Shenzhen (CN); KUAN-HONG HSIEH, New Taipei (TW); YUN XIAO, Shenzhen (CN); SHANG-HUI PI, Shenzhen (CN); SHUANG RUI, Shenzhen (CN)

(21) Appl. No.: 13/729,059

(22) Filed: Dec. 28, 2012

(30) Foreign Application Priority Data
Aug. 20, 2012 (CN) 201210296075X

(51) Int. Cl. G08G 1/123

(52) U.S. Cl. CPC G08G 1/123
USPC 701/117

(57) ABSTRACT

A bus stop includes a storage unit, a communicating unit, an input unit, a control unit, and a display unit. The communicating unit communicates with a server storing relationships among bus terminals, stop information of bus stops and current locations of the bus terminals. The server determines which one or ones travel toward the bus stop according to the current locations of the bus terminals and the location of the bus stop. The display unit displays the current locations of the bus terminals determined by the server. A related system is also provided.

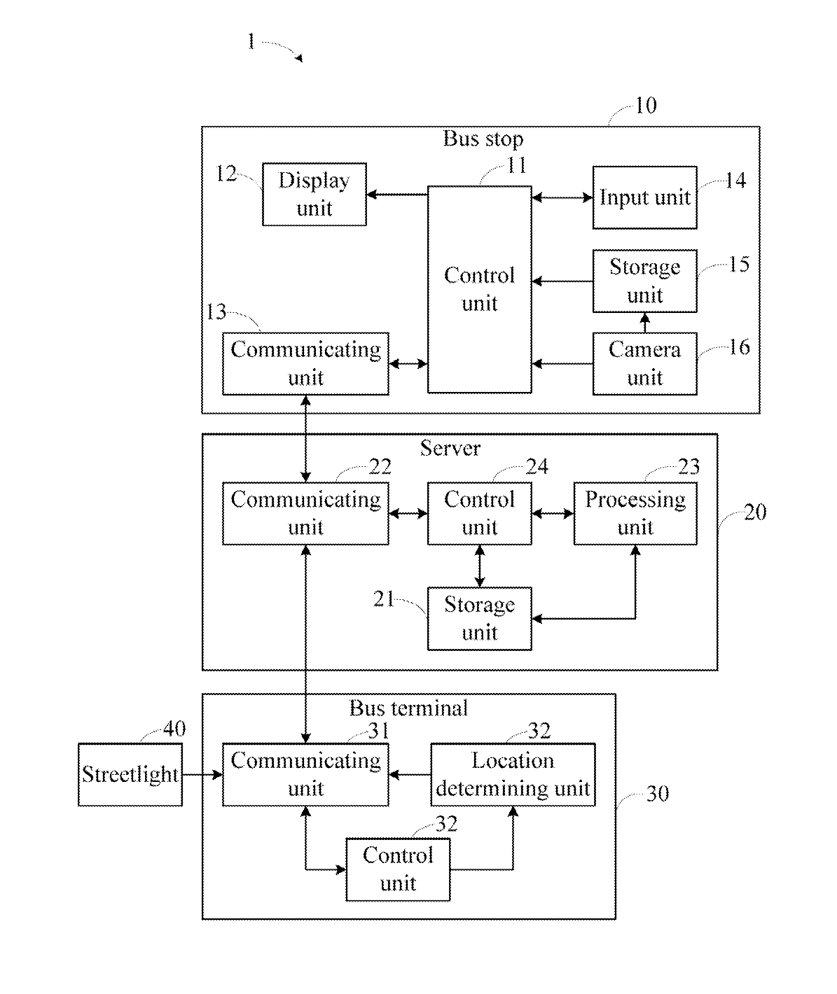

### CROSS-REFERENCE TO RELATED APPLICATIONS

Related subject matter is disclosed in co-pending U.S. patents application with an Attorney Docket Number US46952 and a title of BUS STOP AND SYSTEM CAPABLE OF PROVIDING DETAILED BUS SCHEDULES, which has the same assignees as the current application and were concurrently filed.

### BACKGROUND

1. Technical Field

The present disclosure relates to bus travelling monitoring systems and, particularly, to a bus stop and a system capable of providing detailed bus schedules.

2. Description of the Related Art

Traditional bus stops have signs to show only names of bus routes and names of bus stops along each bus route to passengers. However, the passengers cannot get arrival time of the buses they want to take or traffic condition of the buses travelling, which results in the passengers waiting for the buses blindly, which is inconvenient for passengers, especially when the buses have broke down on the rode or are blocked in a traffic jam. Therefore, there is room for improvement within the art.

### BRIEF DESCRIPTION OF THE DRAWING

The components in the drawing are not necessarily drawn to scale, the emphasis instead being placed upon clearly illustrating the principles of the disclosure. Moreover, in the drawing, like reference numerals designate corresponding parts throughout the several views.

The figure is a diagram block of a system capable of providing detailed bus schedules, according to an exemplary embodiment.

### DETAILED DESCRIPTION

The figure is a system 1 capable of providing detailed bus schedules. The system 1 includes a plurality of bus stops 10, a server 20, and a plurality of bus terminals 30. Each of the plurality of bus terminal 30 communicates with the server 20 via a network, such as Power Line Communication (PLC), Optical Power Line Communication (OPLC) 3G, 4G, GPRS, CDMA, GSM, WiFi, Zigbee, Zwave, IR, NFC, and so on. Each of the plurality of bus terminals 30 is employed in a bus (not shown). In the embodiment, the server 20 is a computer.

Each bus terminal 30 includes a communicating unit 31, a location determining unit 32, and a control unit 33. The location determining unit 32 is configured for obtaining stop information of one or more bus stops 40 along the bus route within a predetermined range, and further determining a current location of the bus terminal 30 according to the obtained stop information. The stop information of each bus stop 40 includes a stop name and a location of the bus stop 40. The control unit 33 is configured for controlling the communicating unit 31 to transmit the current location of the bus terminal 30 determined by the location determining unit 32 and an identification of the bus terminal 30 to the server 20. In the embodiment, the identification of the bus terminal 30 includes data to record a corresponding route number of a bus route the bus terminal 30 takes. In addition, includes data to record a number assigned to the bus terminal 30 when several bus terminals 30 correspond to the same route number, which means, several bus terminals 30 take the same route. In an alternative embodiment, the location determining unit 32 determines the current location of the bus terminal 30, and the control unit 33 controls the communicating unit 31 to transmit the current location of the bus terminal 30 to the server 20 in the predetermined time interval.

The server 20 includes a storage unit 21, a communicating unit 22, a processing unit 23, and a control unit 24. The storage unit 21 is configured for pre-storing a table recording a plurality of identifications of the bus terminals 30, stop information of bus stops along bus routes of the bus terminals 30, and the current locations of the bus terminals 30 correspondingly. The communicating unit 22 is configured for communicating with the plurality of bus terminals 30. When the server 20 receives the current location and the identification of a bus terminal 30 via the communicating unit 20, the control unit 24 is configured for updating the current location recorded in the table corresponding to the identification of the bus terminal 30 with the received current location.

Each bus stop 10 includes a control unit 11, a display unit 12, a communicating unit 13, an input unit 14, and a storage unit 15. The communicating unit 13 is configured for communicating with the server 20. The storage unit 15 is configured for pr-storing the stop information of the bus stop 10, the routes passing the bus stop, and the identifications of all the bus terminals 30 taking those routes. The input unit 14 is mounted toward outside of the bus stop 10, and is configured for generating a first request signal in response to manual operation. In the embodiment, the input unit 14 includes a plurality of mechanical buttons, and each of the mechanical buttons corresponds to a bus route and is configured for being operated to generate a first request signal carrying the route number of the bus route. In an alternative embodiment, the input unit 14 includes a mechanical button corresponds to several or all of the bus route passing the bus stop 10, the mechanical button is configured for being operated to select among the bus routes to generate the first request signal carrying the route number of the selected bus route.

The control unit 11 is configured for obtaining the stop location from the storage unit 15 in response to the received first request signal, generating a second request signal carrying the stop location and the route number parsed from the first request signal, and controlling the communicating unit 13 to transmit the second request signal to the server 20.

When the server 20 receives the second request signal transmitted by the bus stop 10, the processing unit 23 determines one or more bus terminals 30 recorded in the table corresponding to the route number carried by the second request signal. In addition, determines among those bus terminals 30 which one or ones are travelling toward the bus stop 40 according to the current locations of the bus terminals 30 and the location of the bus stop 10. The control unit 24 controls the communicating unit 22 to transmit the current locations of the bus terminals 30, which are traveling toward the bus stop 10 to the bus stop 10. The display unit 12 displays the current locations of the bus terminals 30 transmitted by the server 20.

In the embodiment, the control unit 11 is further configured for comparing the current locations of the bus terminals 30 with the location of the bus stop 10 to determine the nearest bus terminals 30 to the bus stop 10. In addition, the display unit 12 highlights the current location of the nearest bus terminal 30. The control unit 11 is further configured for evaluating a time the nearest bus terminal 30 is assumed to spend to reach the bus stop 10 from its current location, and controlling the display unit 12 to display the time.

In an alternative embodiment, the processing unit 23 is further configured for comparing the current locations of the bus terminals 30 with the location of the bus stop 10 to determine the nearest bus terminals 30 to the bus stop 10, and evaluating the time the nearest bus terminal 30 is assumed to take to reach the bus stop 10 from its current location. The control unit 24 controls the communicating unit 22 to transmit the current location of the nearest bus terminal 30 and/or the time evaluated to the bus stop 10. The control unit 11 of the bus stop 10 controls the display 12 to display the received current location and/or the evaluated time.

In a second embodiment, the system 1 further includes a plurality of streetlights 40. Each of the plurality of streetlights 40 is a pre-stored location. The location determining unit 32 determines the current location of the bus terminal 30 with reference to the locations of nearby streetlights 40.

The bus stop 10 further includes a camera unit 16, mounted toward outside of the bus stop 10 for taking images surrounding the bus stop 10. The images are stored in the storage unit 15. The control unit 11 controls the communicating unit 13 to transmit the images taken by the camera unit 16 to the server 20, and store the images in the storage unit 21. The control unit 24 determines location of abnormal traffic information by analyzing the images transmitted by the plurality of bus stops 10, and further determines the bus terminals 30 travelling towards the determined abnormal traffic location according to the table. The input unit 14 generates an inquiry signal in response to a passenger's operation of the server 20 for inquiring the schedule on his or her expected bus route. The control unit 24 controls the communicating unit 22 to transmit the schedule which the passenger requests to the bus stop 10 correspondingly. The display unit 12 of the bus stop 10 displays the schedule. The passenger thus knows the location of the nearest bus or buses on his or her expected route or routes and whether the nearest bus or buses are blocked down because of abnormal traffic information.

In the embodiment, when an accident or emergency occurs, the input unit 14 is operated by an user to generate an alarming signal. The control unit 11 obtains the images and the location information of the bus stop 10 from the storage unit 15, and controls the communicating unit 13 to transmit the images and the location information to the server 20. The communicating unit 13 further sends a signal to the server 20 to trigger the display of the image and location information on the server 20. Therefore, when the images and the location information are received from the bus stop 10 via the communication unit 22, the control unit 24 stores the images and the location information in the storage unit 21. Meanwhile, the control unit 24 automatically displays the images and the location information on a display unit (not shown) without any human intervention, which helps the people before the display unit timely know the accident or emergency and the location of the accident or emergency, and give help to those involved in the accident/emergency immediately.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A bus stop comprising:
a storage unit configured for pre-storing stop information of the bus stop, the stop information comprising a stop name and a location of the bus stop;
a communicating unit configured for communicating with a server, wherein the server stores a table recording relationships among identifications of a plurality of bus terminals, stop information of a plurality of bus stops, and current locations of the bus terminals, each bus terminal being configured to be mounted on a corresponding bus;
an input unit configured for allowing for a user to select a bus route and generating a first request signal carrying a route number representative of the selected route;
a control unit configured for obtaining the stop location from the storage unit in response to the received first request signal, generating a second request signal carrying the stop location and the route number parsed from the first request signal, and controlling the communicating unit to transmit the second request signal to the server, triggering the server to determine one or more bus terminals recorded in the table associated with the route number and further determining one or more buses which are travelling toward the bus stop according to the current locations of the bus terminals and the location of the bus stop; and
a display unit configured for displaying the current locations of the bus terminals transmitted by the server.

2. The bus stop as claimed in claim 1, wherein the control unit further configured for comparing the current locations of the bus terminals with the location of the bus stop to determine the nearest bus terminals to the bus stop, and controlling the display unit to highlight the current location of the nearest bus terminal.

3. The bus stop as claimed in claim 2, wherein the control unit further configured for evaluating a time the nearest bus terminal is assumed to spend to reach the bus stop from its current location, and controlling the display unit to display the time.

4. The bus stop as claimed in claim 1, further comprising a camera unit configured for capturing images surrounding the bus stop, the images are stored in the storage unit.

5. The bus stop as claimed in claim 4, wherein the control unit further configured for controlling the communicating unit to transmit the images to the server, whereby the server can determine one or more locations of abnormal traffic by analyzing the images and determine the buses traveling towards the one or more locations of the abnormal traffic according to the table.

6. The bus stop as claimed in claim 4, wherein the input unit is further configured for generating an alarming signal in response to a user's operation, the control unit is further configured for obtaining the images and the location information of the bus stop from the storage unit, and controlling the communicating unit to transmit the images and the location information to the server to display the images.

7. The bus stop as claimed in claim 1, wherein the input unit comprising a plurality of mechanical buttons, and each of the plurality of mechanical buttons corresponds to a bus route and configured for being operated to generate the first request signal.

8. A system capable of providing travelling information of buses comprising
a plurality of bus terminals, a plurality of bus stops, and a server communicating with the plurality of bus terminals and the plurality of bus stops, wherein each of the plurality of bus terminals is mounted in a corresponding bus;
each bus terminal configured for determining a current location of the bus terminal, and transmitting the current location of the bus terminal and an identification of the bus terminal to the server;
each bus stop comprising:
a storage unit configured for pre-storing stop information of the bus stop, the stop information comprising a name and a location of the bus stop;
a communicating unit configured for communicating with the server;
an input unit configured for allowing for a user to select a bus route and generating a first request signal carrying a route number representative of the selected bus route; and
a display unit;
a control unit configured for obtaining the stop location from the storage unit in response to the received first request signal, generating a second request signal carrying the stop location and the route number parsed from the first request signal, and controlling the communicating unit to transmit the second request signal to the server;
the server configured for pre-storing a table recording relationships among identifications of the plurality of bus terminals, stop information of the plurality of bus stops, and current locations of the plurality of bus terminals; further configured for determining one or more bus terminals recorded in the table associated with the route number, determining one or more buses which are travelling toward the bus stop according to the current locations of the bus terminals and the location of the bus stop, and transmitting the determined current locations to the bus stop to enable the display unit to display the current locations of the bus terminals.

9. The system capable of providing travelling information of buses as claimed in claim 8, wherein the control unit further configured for comparing the current locations of the bus terminals with the location of the bus stop to determine the nearest one of the bus terminals towards the bus stop, and controlling the display unit to highlight the current location of the nearest bus terminal.

10. The system capable of providing travelling information of buses as claimed in claim 9, wherein the control unit further configured for evaluating a time the nearest bus terminal is assumed to spend to reach the bus stop from its current location, and controlling the display unit to display the time.

11. The system capable of providing travelling information of buses as claimed in claim 8, wherein each bus stop further comprises a camera unit configured for capturing images surrounding the bus stop, the images are stored in the storage unit.

12. The system capable of providing travelling information of buses as claimed in claim 11, wherein the control unit further configured for controlling the communicating unit to transmit the images to the server, the server further configured for determining one or more locations of abnormal traffic by analyzing the images and determining the bus terminals traveling towards the determined locations of abnormal traffic according to the table.

12. The system capable of providing travelling information of buses as claimed in claim 11, wherein the input unit further configured for generating an alarming signal in response to a user's operation, the control unit further configured for obtaining the images and the location information of the bus stop from the storage unit, and controlling the communicating unit to transmit the images and the location information to the server to display the images.

13. The system capable of providing travelling information of buses as claimed in claim 8, wherein the input unit comprising a plurality of mechanical buttons, and each of the plurality of mechanical buttons corresponds to a bus route and configured for being operated to generate the first request signal.

14. The system capable of providing travelling information of buses as claimed in claim 8, wherein the server is further configured for comparing the current locations of the bus terminals with the location of the bus stop to determine the nearest one of the bus terminals towards the bus stop, and transmitting the current location of the nearest bus terminal to the bus stop to display the current location on the display unit.

15. The system capable of providing travelling information of buses as claimed in claim 14, wherein the server further configured for evaluating a time the nearest bus terminal is assumed to spend to reach the bus stop from its current location, and transmitting the time to the bus stop to display the time on the display unit.

16. The system capable of providing travelling information of buses as claimed in claim 8, further comprising a plurality of streetlights configured for pre-storing locations of the streetlights, the bus terminal further configured for determining the current location of the bus terminal with reference to the locations of adjacent streetlights.
